(19) United States
(12) Patent Application Publication
(10) Pub. No.: US 2011/0042554 A1
(43) Pub. Date: Feb. 24, 2011

(54) Light Sensor with Integrated Temperature Sensor Functionality

(75) Inventors: Achim Hilgers, Alsdorf (DE); Bernd Ackermann, Aachen (DE)

Correspondence Address: Philips Intellectual Property and Standards, P.O. Box 3001, Briarcliff Manor, NY, 10510-8001, US

(73) Assignee: KONINKLIJKE PHILIPS ELECTONICS N.V., Eindhoven (NL)

(21) Appl. No.: 12/159,879

(22) PCT Filed: Jan. 5, 2007
(86) PCT No.: PCT/IB07/50032

§ 371 Date: Jul. 2, 2008

(30) Foreign Application Priority Data
Jan. 9, 2006 (EP) 06100163.2

(51) Int. Cl. G01J 1/44; G01K 13/00

(52) U.S. Cl. 250/215; 374/142

(57) ABSTRACT

The invention relates to a light sensor, particularly for LED-based lamps. The light sensor comprises at least one photosensor (1) and a temperature sensor (2). The photosensor (1) and the temperature sensor (2) are integrated on a common substrate in a common housing.

Lamps and lamp systems are increasingly being replaced by lamps and lamp systems based upon light emitting diodes. The major advantage of LED-based lamps is the substantially higher efficiency and the much larger life span of the light emitting diodes. Furthermore, aesthetic factors play a dominant role in many applications. Here, LED-based lamps and light systems may likewise preferably be used, as they offer additional design options.

The originally typical areas of application of light emitting diodes, such as for example signal lamps, are being expanded continuously. Already multiple LED interconnections are used as a replacement also for larger signal lamps, such as for example traffic lights. In the automotive sector also, light emitting diode-lamp systems are used for reversing lamps, stop lights and direction indicator systems. The use of LEDs in headlamps is in an experimental stage.

In future, LED lamps will also be used in the sector of professional lamp systems (specialized markets) and in the consumer sector. In these sectors, a particularly good color quality as well as the possibility of adapting the lamp color (or the color temperature) to different conditions according to the desire of the user is of particular importance. However, this requires certain technical pre-requisites to be met by the LED lamp systems.

As a rule, for example, white light is produced by a combination of several, often differently colored, light emitting diodes. In principle, white light is generated by a color mixture of, for example, red (R), green (G) and blue (B) light emitting diodes. The spectra and brightness levels of the individual LEDs are controlled in such a way that the desired light having the necessary characteristic features develops. Thus, besides the brightness and the color temperature of the white light, different colors may also be set, by controlling, for example, only very special combinations of light emitting diodes by means of a special signal, in order to generate, for example, only red (R) or yellow (as a combination of G and B) light.

These setting possibilities presuppose a specific electronic control of the individual LEDs of a lamp. Furthermore, sensor electronics or sensor logic is necessary, which detects the characteristic of the RGB-based LED lamps in order to communicate this information to the control electronics, which may thereupon manipulate the control of the LEDs in order to achieve the desired operating point. Thus, electronic regulation is necessary to control and set the characteristic of the LED lamp. For this purpose use can be made of photosensitive components and/or temperature-sensitive elements, which detect the spectrum of the lamp and/or the temperature of the LEDs, in order to manipulate properties of the LEDs on the basis of their signals.

Particularly, the high temperatures of the LED-based lamp systems lead to a substantial change of the light spectra. When observing a typical temperature behavior of the spectrum of an LED, it can be ascertained that apart from the change of the wavelength at which the maximum of the radiation takes place, the reduction of this maximum as well as the luminous power itself are critical and lead to a strong influence on the total spectrum of an RGB (A) light. Electronic regulation is necessary to compensate for this effect.

Photosensors and/or temperature sensors are used in known methods of controlling and setting the color or the color temperature as well as the brightness of RGB (A)-based LED lamps and light systems apart from the desired setting of specific spectral combinations, such sensors are also used to keep the lamp characteristics constant as a function of aging of the lamp and temperature fluctuations, so that these effects do not influence the lamp characteristics. For this purpose, the LED characteristics are detected and evaluated by the sensors, in order to then influence the control electronics of the individual LEDs [RGB (A)] according to a fixed algorithm. Usually, the individual electric currents of the LEDs are reduced or increased by amplitude and/or pulse-width modulation, so that the light spectrum of the lamp adopts the desired value.

With the known control methods, it is disadvantageous that only a relatively inaccurate temperature detection of the LEDs is possible. The spectrum that may be measured by means of the photosensors used also proves problematic. This can be attributed to the fact that the actual temperature of the LED semiconductor components cannot be measured, due to the spatially different arrangement of the LEDs as well as the photo and temperature sensors. Furthermore, the photosensors are exposed to another temperature than the LEDs that are to be detected. This hampers the stability of the lamp spectrum as a function of the lamp temperature. When observing the individual components (photosensors, temperature sensors, LEDs) of an RGB (A) light, which are thermally coupled, more or less closely, to a heat sink, different thermal transition resistances result between the heat sink and the temperature sensors, the photosensors and the LEDs.

The invention wants to provide a remedy for this matter. It is an object of the invention to provide a light sensor with reduced temperature sensitivity. According to the invention, this object is achieved by the characteristics of claim 1.

The invention provides a light sensor in which the temperature resistance between photosensors and temperature sensors is minimized and which furthermore enables a higher degree of miniaturization.

In a further version of the invention, the light sensor is manufactured in MOS or CMOS technology. With this technology, both sensor types (photo and temperature sensor) can be manufactured.

In an embodiment of the invention, the temperature sensor is a semiconductor-based thermo-element. Such so-termed thermistors are polycrystalline, temperature-dependent semiconductor resistors with a negative (negative temperature coefficient resistors; NTC resistors) or positive (positive temperature coefficient resistors; PTC resistors) temperature coefficient. Thermistors render an accurate measurement possible and can be manufactured in a cost-effective manner.

In a further embodiment of the invention, the temperature sensor and the photosensor are connected in series, the temperature sensor being a thermo-element with PCT behavior. This, in combination with a suitably dimensioned thermo-element, enables a constant behavior of the photocurrent to be obtained with respect to the temperature, as a result of which the temperature dependence of the photosensor can be compensated.

In an further version of the invention, a tap is provided between the photosensor and the temperature sensor, which tap is arranged so as to be directed outwards with respect to the housing for detecting the ambient temperature.

An amplifier element can additionally provided in the light sensor. By integrating an amplifier element in the same semiconductor technology (MOS or CMOS), the functionality of the combined photo-temperature sensor can be expanded. It is advantageous if the amplifier element is a transimpedance converter.

In a further embodiment of the invention, a signal filter module is additionally provided behind the output of the amplifier. By means of this signal filter module, the HF-switch signals (LEDs are usually driven by Pulse Width Modulation (PWM=Pulse Width Modulation)) are filtered out, so that a high-quality sensor signal can be tapped at the output. The signal filter module is preferably a low-pass filter.

Other versions and embodiments of the invention are indicated in the further sub-claims. An example of the invention is shown in the drawings and will be described in detail hereinafter.

In the drawings:

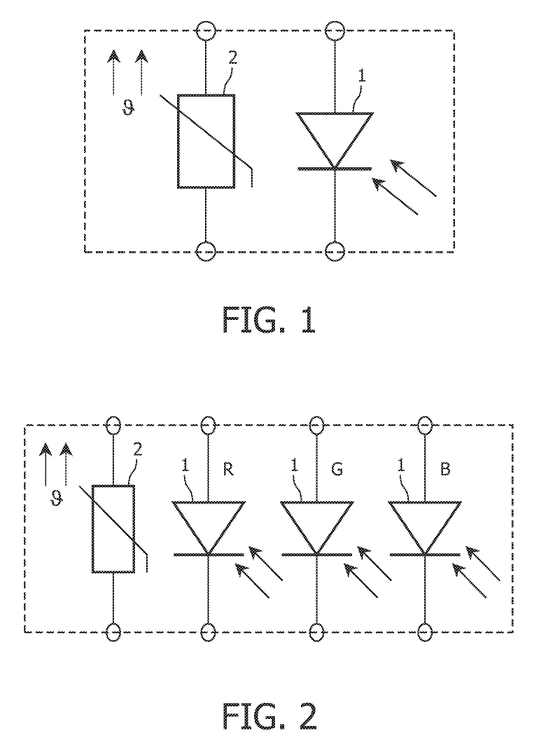

FIG. 1 shows the schematic representation of the principle of a light sensor with an integrated photo and temperature sensor;

FIG. 2 shows the schematic representation of the principle according to FIG. 1 in multiple sensor design;

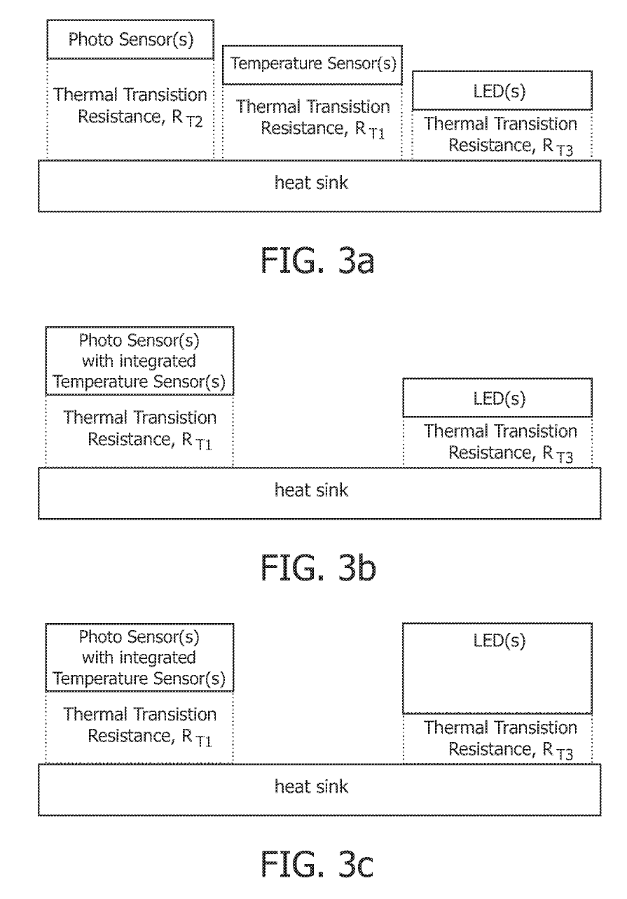

FIG. 3 shows a basic block diagram with temperature transition resistances of a sensor-supervised LED light

a) with a separate photo and temperature sensor (state of the art);
b) with an integrated photo and temperature sensor arranged in the immediate vicinity of the LEDs;
c) with an integrated photo and temperature sensor arranged at a distance from the LEDs;

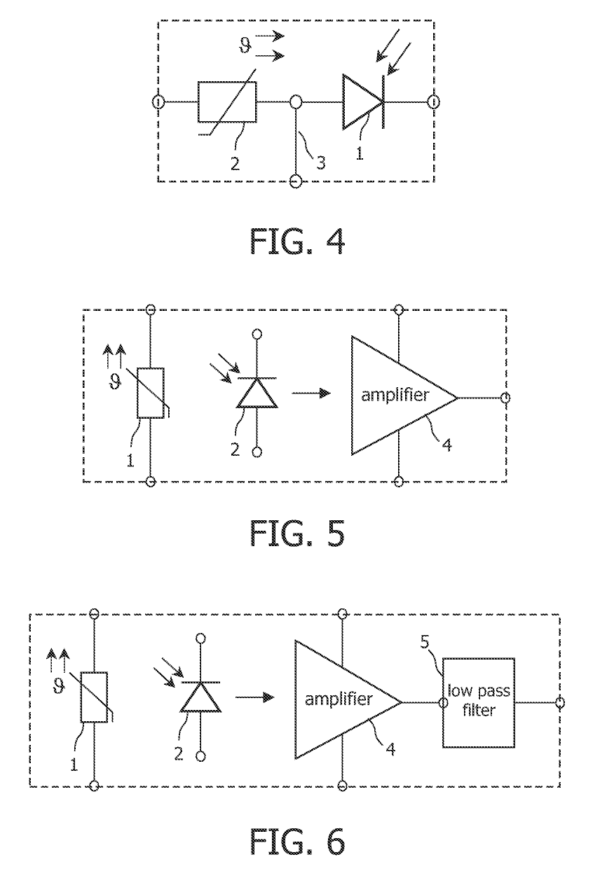

FIG. 4 shows the schematic representation of the principle of a light sensor according to FIG. 1 with a tap between the photo sensor and the temperature sensor for determining the ambient temperature;

FIG. 5 shows the schematic representation of the principle of a light sensor according to FIG. 1 with an integrated amplification of the photocurrent, and

FIG. 6 shows the schematic representation of the principle of a light sensor according to FIG. 5 with additional filter functionality.

The light sensor selected as an example of embodiment comprises at least one photosensor 1 as well as at least one temperature sensor 2 on a common substrate and in a common housing. The MOS or CMOS technology lend themselves as a possible semiconductor technology, as both sensor types (photo and temperature sensor) may be manufactured by these technologies. FIG. 1 shows the principle of the combined light sensor. A temperature sensor 2 as well as a photo sensor 1 are accommodated on a substrate and in a housing, so that the temperature transition resistance between the photosensor 1 and the temperature sensor 2 is negligibly small. In FIG. 1, a simple minimal solution is represented. Both sensors 1, 2 have separately tappable contacts 3 for the photodiode signals (usually a photocurrent) as well as for the temperature sensor information (normally an ohmic resistance value).

The photosensor 1 may be a simple, relatively broadband sensor, which covers the entire spectrum of an application (for example, visible light, UV, IR, etcetera) or a relatively narrow-band sensor, which only detects small sub-portions of a frequency spectrum. In order to generate optical filters with corresponding properties, sufficient possibilities are known to those skilled in the art. In principle, color filters as well as interference filters can suitably be used, which are arranged above the light-sensitive semiconductor structures.

FIG. 2 shows a solution with several photosensors 1, which are each tuned to a specific frequency range. Here, the three basic colors RGB can suitably be used. Particularly color sensors that correspond to the sensitivity of the human eye are of particular importance. Other photosensor arrangements and combinations, which are tuned to frequencies not mentioned here, are likewise conceivable. Also, a plurality of photodiodes with the same spectral sensitivity may be spatially separated from each other and connected in parallel at the same time, in order to minimize optical mismatches and increase the photocurrent. In principle, other photosensitive elements such as, for example, phototransistors, solar cells, photoresistors, etcetera, may also be used in place of the represented photodiodes.

Semiconductor-based thermo-elements can suitably be used as temperature sensor 2; they generally have a positive temperature coefficient and thus exhibit PTC (Positive Temperature Coefficient) or PTC resistor behavior. The use of a semiconductor-based Negative Temperature Coefficient (NTC) resistor is likewise possible. But, in principle, NTC or PTC- resistors (metal layer temperature sensors) which are mounted on the carrier substrate of the photodiode may also be used.

The block diagram of a LED-based light resulting from the use of the light sensor with integrated photo and temperature sensor is represented in FIG. 3. FIG. 3 b) relates to the case where the light sensor is arranged in the immediate vicinity of the LEDs. This has the advantage that the temperature of the LEDs can be detected well, and there is only a small temperature transition resistance (R_{T1}) between the LEDs and the sensor(s). However, with this arrangement, if necessary the photosensor 1 may only detect portions of the entire light spectrum. FIG. 3 c) shows the case that the light sensor is arranged at some distance from the LEDs, as a result of which there is a larger thermal transition resistance (R_{T1}) between the LEDs and the sensor(s) 1, 2. However, this arrangement offers the advantage that the photosensor part of the light sensor can better capture the light spectrum.

Independent of the arrangement of the light sensor in relation to the LEDs, however, the advantage vis-à-vis the conventional separate sensor solutions, represented in FIG. 3 a), can be recognized clearly. Instead of the two different temperature transition resistances (R_{T1} and R_{T2}), now only one is present. This simplifies the color control of the lamp, since there is one less unknown quantity, and thus a more precise and faster color regulation can be generated. Furthermore, the temperature sensitivity of the photosensor 1 itself can be accurately detected and thus can be compensated easily. As a result, the sensor data is more precise and thus a more exact color setting or correction of the control electronics of the individual LED (s) can be carried out.

Furthermore, the number of components is reduced, resulting in a smaller assembling and wiring expenditure, which enables the manufacture of smaller, simpler and thus more economical LED based RGB(A) lamps.

In the embodiments according to FIGS. 1 and 2, the thermo-element 2 is series-connected to the photosensor 1. As the intrinsic conductivity of the semiconducting photosensor 1 increases with temperature (reverse current becomes larger, forward resistance becomes smaller), and hence said photosensor exhibits NTC behavior, a suitable serial temperature compensation element is one exhibiting PTC behavior. By suitable dimensioning of the thermo-element in the arrangement represented in FIGS. 1 and 2, a constant behavior of the photocurrent with respect to the temperature can be achieved, so that the entire temperature dependence of the photosensor is compensated for.

Furthermore, there is a possibility of using the light sensor to detect the actual ambient temperature by arranging a suitable tap 3 between photosensor 1 and temperature sensor 2 in such a manner that it is directed outwards (with respect to the housing). Hereby, temperature compensation is enabled. The most different connection combinations (series, parallel connections and mixed circuits of several temperature sensors) may be used.

The functionality of the photo and temperature sensor combined in the light sensor may be expanded by integrating an amplifier element 4 (in the same semiconductor technology, i.e. MOS or CMOS). The normally extremely small photocurrent, which is generated due to the incidence of light, must necessarily be strengthened, so that the signals can be processed further. For this purpose, so-termed transimpedance converters with relatively high amplification factors can suitably be used, which have been sufficiently described in the professional literature. If the amplifier 4 is arranged in the immediate vicinity of the photosensor 1, then the spurious signals are reduced enormously due to the substantially shorter conducting paths, so that the operation of the amplifier 4 features a substantially lower noise level and a substantially reduced sensitivity. This expansion is represented schematically in FIG. 5.

Moreover, a signal filter module 5 may be fitted additionally behind the output of the amplifier, so that the HF switch signals (as a rule LED(s) are driven by a PWM) are filtered out and a high-quality sensor signal can be tapped at the output. This may then be supplied directly to the control electronics of the LED-based RGB(A) lights. FIG. 6 shows the corresponding basic diagram. A filter component that can suitably be used is a low-pass filter, of which the most diverse topologies have been described in the professional literature.

In a further embodiment, besides the operating voltage connections, the amplifier mentioned above may also have additional terminals, in order to define, for example, the amplification factor and/or the minimum and the maximum output voltage. This is done via additional components (for example, ohmic resistors), which are attached to the connections provided for this purpose. The filter characteristic of the low-pass filter may be modified in the same way (by ohmic resistors and/or capacitors and/or inductances).

1. A light sensor for LED-based lamps comprising an integrated photo and temperature sensor, comprising at least one photosensor (1) and at least one temperature sensor (2) disposed on a common substrate in a common housing.

2. A light sensor of claim 1, wherein the light sensor is manufactured by MOS or CMOS technology.

3. A light sensor of claim 1 wherein the temperature sensor (2) is a semiconductor-based thermo-element.

4. A light sensor of claim 1, wherein the temperature sensor (2) and photosensor (1) are connected in series, the temperature sensor (2) being a thermo-element with a PTC behavior.

5. A light sensor of claim 1, wherein the integrated photo and temperature sensor further comprises a tap (3) disposed between the at least one photosensor (1) and the at least one temperature sensor (2) and directed outwards with respect to the housing for detecting the ambient temperature.

6. A light sensor of claim 1 further comprising an amplifier element (4).

7. A light sensor of claim 6, wherein the amplifier element (4) is a transimpedance converter.

8. A light sensor of claim 6, further comprising a signal filter module (5) provided behind the output of the amplifier (4).

9. A light sensor of claim 6 wherein the signal filter module (5) is a low-pass filter.
